(19) United States
(12) Patent Application Publication
(10) Pub. No.: US 2006/0282318 A1
(43) Pub. Date: Dec. 14, 2006

(54) METHOD OF SUSPENDING AN INTERNET ADVERTISING CAMPAIGN FOR AN ADVERTISED WEB SITE WHEN THE WEB SITE IS INACCESSIBLE

(75) Inventors: Baird Larson, Wilmette, IL (US); Dante Monteverde, Barrington Hills, IL (US); Arsen Vladimirskiy, Chicago, IL (US)

Correspondence Address: SEYFARTH SHAW LLP, 131 S. DEARBORN ST., SUITE2400, CHICAGO, IL, 60603-5803, US

(73) Assignee: EMERgency 24, Inc., Chicago, IL (US)

(21) Appl. No.: 11/383,298

(22) Filed: May 15, 2006

Related U.S. Application Data
(60) Provisional application No. 60/689,186, filed on Jun. 10, 2005.

(51) Int. Cl. G06Q 30/00

(52) U.S. Cl. 705/14

(57) ABSTRACT

A method of suspending an Internet advertising campaign for a web site that is inaccessible to an Internet user so that an operator of the web site does not incur Pay-Per-Click charges while the web site is inaccessible, comprising the steps of determining the accessibility of the web site, and if the web site is inaccessible, suspending the Internet advertising campaign for the web site so the Internet user cannot select a Pay-Per-Click advertisement for the web site.

### RELATED APPLICATIONS

This application claims the benefit of the filing date of co-pending U.S. provisional patent application No. 60/689,186, filed on Jun. 10, 2005.

### BACKGROUND OF THE INVENTION

The present invention relates generally to Internet advertising, and, more particularly, to monitoring the accessibility of web sites, typically accessible via a hyperlink provided in a search result list or other advertisement, and disabling access to the hyperlink or advertisement if it is determined that the web site is inaccessible.

When an Internet user conducts a search query at a Internet search provider, a search result listing comprising a plurality of hyperlinks that are relevant to the search query are provided in a well-known manner. Currently, if an Internet user selects the hyperlink, returned in the search result list, for a web site that is generally accessible, but is temporarily inaccessible for some reason, such as, for example, a technical malfunction with the web site host server, an error message is provided to the Internet user that the web site is not available. In such instances, such message occurs only after selection of the hyperlink, because there is no method for the search result provider to ensure that the web sites attributable to the returned hyperlinks are accessible.

An advertising campaign for a web site generally consists of the web site's Pay-Per-Click search engine placement and Pay-Per-Click banner or advertisement placements. With Pay-Per-Click search engine placement, Internet site promoters bid for placement in a search return list by bidding monetary amounts for certain keywords or keyword phrases. Generally, the higher the bid amount, the greater the chance of being listed higher in a search return list, which is provided in response to a search query for a keyword in a well-known manner. Generally, the higher a hyperlink is in a search result list, the greater the chance of an Internet user selecting the hyperlink. In Pay-Per-Click search engines, Internet site promoters pay the bid monetary amount each time an Internet searcher clicks on a hyperlink listed in a search result list, regardless if the Internet user is forwarded to the web site owner's web site.

Other methods of Internet advertising include placement of Pay-Per-Click banners or advertisements, which are hyperlinked to an advertised web site, on an associate web site. In such instances, the advertised web site pays the associate web site, which displays the banner or advertisement, a fee each time the banner or advertisement is selected by an Internet user that is visiting the associate web site. For example, if an Internet user is visiting a web site relating to books (the associate web site), a web site selling books (the advertised web site) may place a hyperlinked advertisement on the associate web site, with the intention being that an Internet user that visits the associate web site may also be interested in visiting the advertised web site.

Typically, the banner or advertisement placement is provided to the associate web site by an intermediary Internet advertising service, also known as a Pay-Per-Click service. Also, typically, the search results lists, and placement of hyperlinks within the search results lists, are provided to search providers by a Pay-Per-Click service. In this regard, for example, a promoter of a web site may contract with a Pay-Per-Click service, which will then distribute advertisements and banners of the web site to a plurality of associate web sites, as well as provide a placed hyperlink to the web site to a plurality of search engine providers in response to a search query.

It will be appreciated that, depending on the amount of Internet users that select a web site's advertisements, banners or hyperlinks, operators of such advertised web sites can spend thousands of dollars a month on advertising campaigns. Currently, with Pay-Per-Click advertising systems, the web site promoter is charged the moment that the Internet user selects the respective hyperlink or advertisement display, regardless if the hyperlinked or advertised web site is actually displayed or accessible to the Internet user. In this case, the web site promoter is paying money even though Internet users are not being transferred to the web site. Further, in instances where an Internet user selects the advertisement or hyperlink of an inaccessible web site, the web site's credibility and reputation is generally damaged because the Internet user cannot access the web site.

Accordingly, there is a need to monitor the accessibility of a web site and temporarily suspend the web site's advertisement campaign when the web site is inaccessible to ensure that the web site operator does not incur Pay-Per-Click charges while the web site is inaccessible.

### BRIEF SUMMARY OF THE INVENTION

The present invention provides a method of periodically checking the availability or accessibility of web sites, or portions thereof, and temporarily suspends the advertisement campaign of a web site if it is determined to be unavailable or inaccessible by not providing or listing the hyperlink to the unavailable web site in a search result listing or by not providing or listing the advertisement to the unavailable web site on an associate's web site.

In an embodiment, the method can ping web sites, load http headers of certain web pages of the web site, or load a entire web page of a web site, to check the availability or accessibility of a web site, at predetermined frequencies. In the event that, for example, pinging a web site fails, which is an indication that the web site is inaccessible to an ordinary Internet user, another test may be conducted in order to confirm that the web site is indeed inaccessible or if it was an intermittent problem or a problem with the checking methods. If a web site, or a portion thereof, is determined to be inaccessible, a failure notice may be noted in a database, which suspends the advertisement campaign of the web site, so that when the hyperlink or advertisement for that web site is to be used, the hyperlink or advertisement can be made inaccessible to Internet users so Internet users do not select the hyperlink or advertisement, thus saving Pay-Per-Click costs to the operator of the web site while the web site is inaccessible. In an embodiment, a suspension of the advertisement campaign for a web site ensures that the hyperlink is not provided to search engine providers or the advertisement is not provided to associate web sites. Further, continued monitoring of the inaccessible web site, or portions thereof, occurs so that once accessibility of the web site has been restored, the advertisement campaign can be reinstated and normalized access to the hyperlink or advertisement can resume.

### BRIEF DESCRIPTION OF THE DRAWINGS

For the purpose of facilitating an understanding of the subject matter sought to be protected, there is illustrated in the accompanying drawings embodiments thereof, from an inspection of which, when considered in connection with the following description, the subject matter sought to be protected, its construction and operation, and many of its advantages, should be readily understood and appreciated.

FIG. 1 is a schematic flow chart depicting an embodiment of the present invention.

FIG. 2 is an example deactivation notice deliverable to an operator of an inaccessible web site provided by an embodiment of the present invention.

FIG. 3 is an example reactivation notice deliverable to an operator of a web site that has accessibility restored provided by an embodiment of the present invention.

### DETAILED DESCRIPTION OF THE INVENTION

The present invention provides a web site accessibility system comprising a method of periodically checking the availability or accessibility of web sites, or portions thereof, and temporarily suspends the advertisement campaign of a web site if it is determined to be unavailable or inaccessible to a normal Internet user by not providing or listing the hyperlink to the inaccessible web site in a search result listing or by not providing or listing the advertisement to the inaccessible web site on an associate's web site. For example, a portion of a retail web site may comprise a credit card acceptance web page to complete a sale to an Internet user. In this instance, while the remainder of the retail web site may be accessible to the Internet user, the advertisement campaign may be suspended if the credit card acceptance portion of the web site is inaccessible since the retail web site is unable to accept any orders due to its inability to accept credit card information.

It will be appreciated that while an embodiment of the present invention is operable with advertisement campaigns, such as Pay-Per-Click search engines and Pay-Per-Click banners and advertisements, the present invention will operate equally well with any search engine or other hyperlink placement system. It will further be appreciated that the term “advertising campaign,” as used herein, includes, among other things, typical Internet-related Pay-Per-Click activities, such as, for example, placement of a hyperlink to the web site being advertised in a search result list, or placement of a hyperlink, banner, or other advertisement to the web site being advertised on an associate web site. In such instances, the advertised web site pays a fee each time the hyperlink, advertisement or banner is clicked by an Internet user.

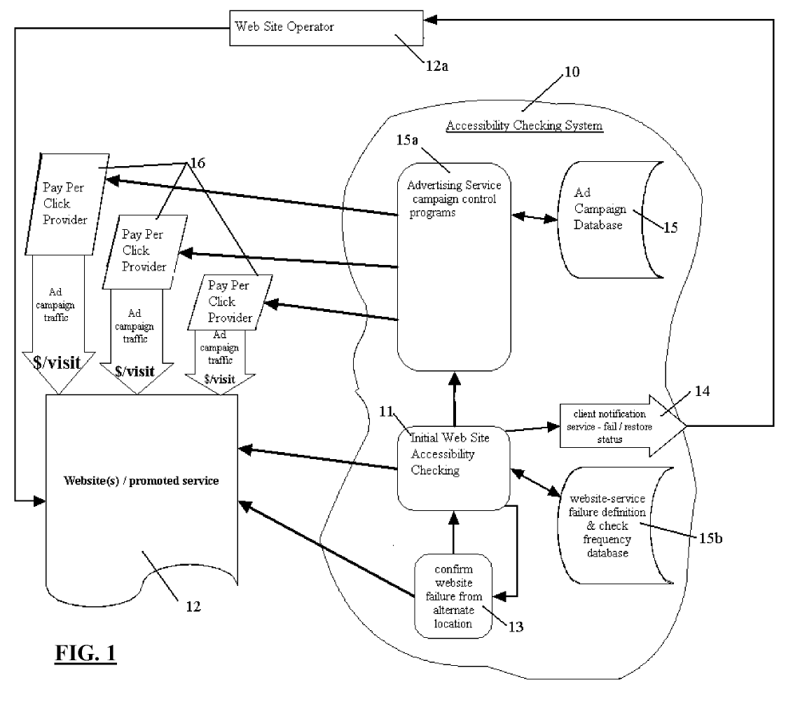

Referring to FIG. 1, in an embodiment, the accessibility checking system 10 comprises the steps of determining or checking the accessibility 11 of a certain portion of a web site, or the entire web site 12, generally accessible on the Internet to a normal Internet user, and, if the portion of the web site or the entire web site is determined to be inaccessible to a normal Internet user, the advertising campaign for the web site may be suspended so that Internet users cannot select an advertisement or hyperlink for the web site 12 while it is inaccessible. In this regard, the operator 12a of the web site 12 does not incur Pay-Per-Click charges while the web site 12 is temporarily inaccessible to Internet users.

In an embodiment, if the web site 12, or a portion thereof, is determined to be inaccessible by the accessibility checking system 10, the accessibility checking system continues monitoring the accessibility of the web site 12, or the inaccessible portion thereof, at a predetermined frequency. Once the web site 12, or the inaccessible portion thereof, again becomes accessible to normal Internet users, the advertising campaign of the web site 12 can be reinstated, so Internet users can select an advertisement or hyperlink to the web site in a well-known manner.

In an embodiment, if it is determined that the web site 12, or a portion thereof, is inaccessible to a normal Internet user, then an additional confirmatory check 13 may be conducted to ensure that the web site 12, or portion thereof, is indeed inaccessible before suspending the advertisement campaign of the web site 12. In this regard, if the inaccessibility was caused by a momentary problem, or if the checking methodology was erroneous, the advertisement campaign of the web site 12 will not be inappropriately suspended.

Determining the accessibility of a web site 12 to a normal Internet user may comprise a number of well-known, Internet-related tools and procedures. For example, to determine the accessibility of a web site 12, or a portion thereof, the Internet Protocol address (IP) could be pinged using the well-known ping command, or the http header information of a web page generally accessible via the web site can be loaded or accessed in a well-known manner, or an entire web page generally accessible via the web site can be loaded or accessed in a well-known manner. It will be appreciated if any one of these tests for accessibility fail, then it is an indication that the web site, or a portion thereof, is inaccessible to a normal Internet user. It will further be appreciated that other well-known, Internet-related methods of checking or determining the accessibility of a web site, or a portion thereof, could be used without departing from the true scope and spirit of the present invention.

If a web site 12 is determined to be inaccessible by a first or initial test 11, the accessibility of the web site 12 may be tested an additional time 13 to ensure that the web site 12, or portion thereof, is indeed inaccessible prior to suspension of the advertisement campaign. In an embodiment, the accessibility of the web site 12 is conducted with a second test which is different than the first test which initially determined that the web site, or a portion thereof, was inaccessible. For example, if a ping test of a web site determines that the web site is inaccessible, then an attempt to load or access the http header of a web page of the web site may be conducted. If this test also fails, additional tests may further be conducted to confirm inaccessibility of the web site, or portion thereof. If one or more additional tests fail, then it can be assumed that the web site, or a portion thereof, is inaccessible to a normal Internet user, and the advertisement campaign for the web site can be suspended.

In another embodiment, if a first test fails from one geographic location, another geographic location can be utilized. For example, if a ping test fails from a first geographical location, another test, such as ping or loading of an http header, may be conducted at a different second geographical location. In this scenario, such repetitive tests at different geographical locations ensures that the failure was not caused by any technical problem with the communication system located between the first test location and the possibly inaccessible web site.

In an embodiment, the testing of a web site 12 is determined at a frequency that is predetermined by the operator or promoter 12a of the web site 12. For example, upon signing up or enlisting for a service that incorporates or sells the advertising checking system of the present invention, an operator or promoter of the web site can choose testing of his web site at frequencies of every 5 minutes, 10 minutes, 15 minutes or 30 minutes. For example, if a web site operator chose a frequency of every 5 minutes, then the accessibility of his web site would be tested every 5 minutes.

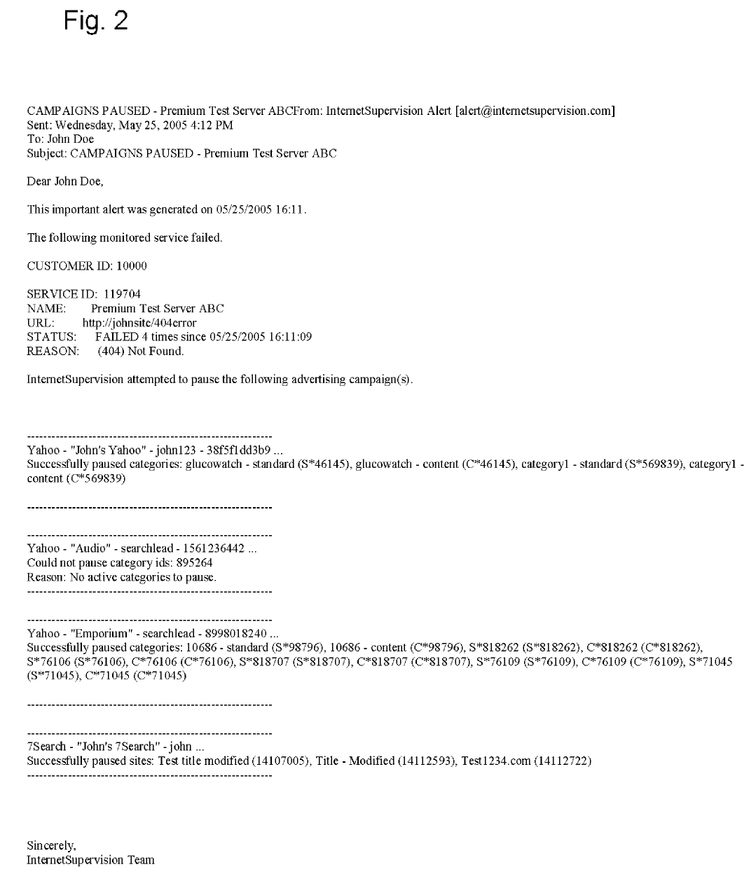

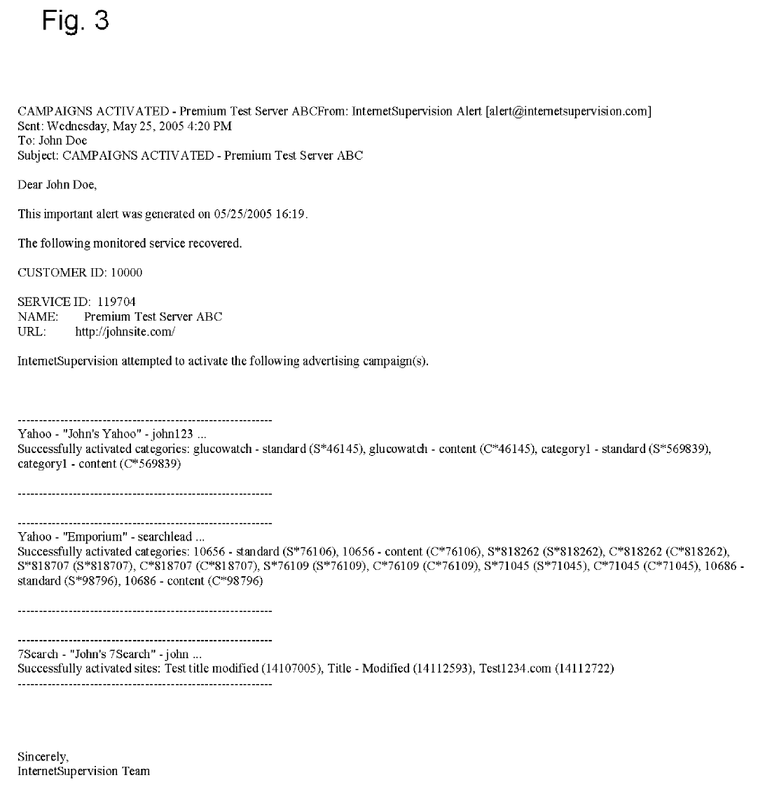

In an embodiment, if the web site 12, or a portion thereof, is determined to be inaccessible and the advertisement campaign of the web site 12 is suspended, then a notice 14 to the operator 12a of the web site 12 may be provided so that the operator 14 knows that his web site 12, or a portion thereof, is inaccessible and the advertisement campaign has been suspended. The notice 14 may be an automatically generated message that is deliverable to the operator 12a of the web site 12. For example, the message may be an electronic mail message, such as that shown in FIG. 2. Once it has been determined that the web site 12, or portion thereof, is again accessible and the advertisement campaign has been restored, an automatically generated notice or message 14 may be sent to the operator. An example of such notice is shown in FIG. 3.

In an embodiment, an advertising campaign database 15 may be provided, which is generally accessible to a plurality of Pay-Per-Click providers 16. A software system 15a may be used to facilitate accessibility for the Pay-Per-Click providers 16 in a well-known manner. The advertising campaign database 15 may include, among other things, information relating to the type of advertisement campaign that the web site operator has engaged in, for example, banner or advertisement placement, information relating to the URL or location of the web site, the status of accessibility to the web site, or a portion thereof, and the frequency for testing or checking the accessibility of the web site. Information contained within the database may be split among a plurality of databases 15b. In an embodiment, if a web site 12, or a portion thereof, is determined to be inaccessible, as described above, a failure alert for the web site 12 may be created and noted in the database 15 for such inaccessible web site 12. In an embodiment, when a Pay-Per-Click provider 16 accesses the database 15 in order to obtain a hyperlink, advertisement or banner for the web site, in a well-known manner, the accessibility checking system 10 determines if there is a failure alert noted in the database 15 for the web site 12, which indicates that the web site 12, or a portion thereof, is inaccessible and the web site's advertisement campaign is suspended. If a failure alert is noted in the database 15 for the web site 12, the accessibility checking system 10 suspends the advertisement campaign, and makes any advertisement, such as, for example, hyperlinks, banners or other advertisements, inaccessible to normal Internet users so such Internet users cannot select such hyperlinks, banners or other advertisements. In an embodiment, when a web site's advertisement campaign is suspended, the web site's hyperlink, banner or other advertisement can be transferred to the requesting Pay-Per-Click provider 16, so that it is displayable to a normal Internet user, but such hyperlink, banner or other advertisement is not selectable to the Internet user. In another embodiment, when a web site's advertisement campaign is suspended, the web site's hyperlink, banner or other advertisement is not transferred to the requesting Pay-Per-Click provider 16, so it is not displayable to a normal Internet user.

If a failure alert is noted in the database 15 for a web site 12, indicating that the web site 12, or a portion thereof, is currently inaccessible, the accessibility of the inaccessible web site, or portion thereof, is continually monitored so that once the accessibility of the web site 12, or portion thereof, is restored, the failure alert can be removed from the database 15 and the web site's advertisement campaign and be resumed. In an embodiment, the continued monitoring of the inaccessible web site may include testing the web site at the predetermined frequency, as set forth above.

As set forth above, the present invention is described generally for Pay-Per-Click services, such as advertisement or banner placement on affiliate web sites, or delivery and placement of a hyperlink is a search result list. It will be appreciated that the present invention can also operate in any type of hyperlink placement system, such as, for example, non-sponsored or non-Pay-Per-Click services or search engines, without departing from the scope and spirit of the present invention.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method of suspending an Internet advertising campaign for a web site when a portion of the web site is inaccessible to an Internet user, comprising the steps of determining the accessibility of the portion of the web site, and, if the portion is inaccessible, suspending the Internet advertising campaign for the web site so the Internet user cannot select an advertisement or hyperlink for the web site.

2. The method as claimed in claim 1 wherein the step of, suspending the Internet advertising campaign for the web site so the Internet user cannot select an advertisement or hyperlink for the web site, includes continuing monitoring the accessibility of the portion of the web site.

3. The method as claimed in claim 2 further comprising the step of, after the portion of the web site is accessible, reinstating the Internet advertising campaign so the Internet user can select an advertisement or hyperlink for the web site.

4. The method as claimed in claim 2 wherein the step of, if the portion of the web site is inaccessible, suspending the Internet advertising campaign for the web site so the Internet user cannot select an advertisement or hyperlink for the web site, includes checking the accessibility of the portion of the web site at least one additional time before suspending the Internet advertising campaign for the web site.

5. The method as claimed in claim 1 wherein the step of determining the accessibility of the portion of the web site includes pinging the portion of the web site, loading a http header of a web page of the web site, or loading a web page of the web site, at a predetermined frequency.

6. The method as claimed in claim 5 wherein the predetermined frequency is chosen by an operator of the web site.

7. The method as claimed in claim 1 wherein the step of, if the portion of the web site is inaccessible, suspending the Internet advertising campaign for the web site so an Internet user cannot select an advertisement or hyperlink for the web site, includes providing a notice to an operator of the web site.

8. The method as claimed in claim 7 wherein the notice includes an automatically generated message deliverable to the operator.

9. The method as claimed in claim 8 wherein the message is an electronic mail message.

10. A method of suspending an Internet advertising campaign for a web site when a portion of the web site is inaccessible to an Internet user, comprising the steps of:
providing a database which is accessible to a plurality of Pay-Per-Click providers;
at a predetermined frequency, determining the accessibility of the portion of the web site by pinging the portion of the web site, loading a http header of a web page of the web site, or loading a web page of the web site;
if the portion of the web site is determined to be inaccessible, creating a failure alert for the web site in the database,
after a provider accesses the database for obtaining an advertisement or hyperlink for the web site, determining if there is a failure alert for the web site,
if a failure alert is present for the web site, making the advertisement or hyperlink inaccessible to the Internet user,
if a failure alert is present for the web site, continue monitoring the accessibility of the portion of the web site, and
after accessibility of the portion of the web site has been restored, removing the failure alert for the web site.

11. The method as claimed in claim 10 wherein the step of, if the portion of the web site is determined to be inaccessible, creating a failure alert for the web site in the database, includes providing an automatically generated message deliverable to an operator of the web site.

12. The method as claimed in claim 10 wherein the predetermined frequency is determined by an operator of the web site.

13. The method as claimed in claim 10 wherein the step of, at a predetermined frequency, determining the accessibility of the web site by pinging a portion of the web site, loading a http header of a web page of the web site, or loading a web page of the web site, is automatically conducted by a computer system.

14. A method of ensuring that a hyperlink directed to a web site, which is typically accessible, in a search result list that is provided in response to a search query is not accessible in the search result list if a portion of the web site is inaccessible, comprising the steps of:
providing a database having information relating to the status of accessibility of the web site; wherein the database is accessible to a plurality of search engine providers, each provider being capable of accessing the database to conduct a keyword query that is initiated by an Internet user to create the search result list;
determining the accessibility of the portion of the web site;
if the portion of the web site is determined to be inaccessible, checking the accessibility an additional time;
if the portion of the web site is determined to be inaccessible after checking the accessibility an additional time, creating a failure alert for the web site in the database;
after a provider accesses the database and the web site is determined to be listed in the keyword query, determining if there is a failure alert for the web site;
if a failure alert is present for the web site, making the hyperlink inaccessible to the Internet user in the search result list; and
if a failure alert is present for the web site, continue monitoring the accessibility of the web site.

15. The method as claimed in claim 14 further comprising after accessibility of the portion of the web site has been restored, removing the failure alert for the web site.

16. The method as claimed in claim 14 wherein the step of, if the portion of the web site is determined to be inaccessible after checking the accessibility an additional time, creating a failure alert for the web site in the database, includes providing an automatically generated message deliverable to an operator of the web site.

17. The method as claimed in claim 14 wherein the step of determining the accessibility of the portion of the web site is automatically conducted by a computer system.

18. The method as claimed in claim 14 wherein the step of determining the accessibility of the portion of the web site includes pinging the portion of the web site, loading a http header of a web page of the web site, or loading a web page of the web site, at a predetermined frequency.
